(19) United States
(12) Patent Application Publication
(10) Pub. No.: US 2019/0264006 A1
(43) Pub. Date: Aug. 29, 2019

(54) NEW PLASTICIZED COMPOSITIONS COMPRISING CELLULOSE ACETATE

(71) Applicant: Rhodia Acetow Gmbh, Freiburg (DE)

(72) Inventors: Alexandra ARGOUD, La Chapelle-de-la-Tour (FR); Olivier ANDRES, Mions (FR); Caroll VERGELATI, Saint Baudille de la Tour (FR)

(21) Appl. No.: 16/063,030

(22) PCT Filed: Dec. 22, 2016
(86) PCT No.: PCT/EP2016/082324

§ 371 Date: Jun. 15, 2018

(30) Foreign Application Priority Data
Dec. 22, 2015 (EP) 15307103.0

(51) Int. Cl. C08L 1/12; C08L 3/06; C08L 3/12; C08K 5/00; C08K 5/11

(52) U.S. Cl. CPC C08L 1/12; C08L 3/06; C08L 3/12; C08L 2201/08; C08K 5/11; C08K 2201/007; C08K 5/0016

(57) ABSTRACT

New plasticized compositions comprising cellulose acetate The present invention concerns a composition comprising: cellulose acetate, starch acetate, and at least one plasticizer, wherein cellulose acetate is present in an amount of at least 50% by weight with respect to the total weight of cellulose acetate, starch acetate and plasticizer(s), and wherein said at least one plasticizer is present in an amount of at most 18% by weight with respect to the total weight of cellulose acetate, starch acetate and plasticizer(s). The present invention also relates to a process for the manufacture of a plasticized article, to the use of said composition for producing a plasticized article, and to the use of starch acetate to prevent or diminish the exudation of one or more plasticizers from plastic materials containing cellulose acetate and such plasticizer(s), and/or to increase the maximal use temperature in application for a material comprising cellulose acetate.

This application is a national phase filing under 35 USC 371 of International Application No. PCT/EP2016/082324, filed on Dec. 22, 2016, which claims priority to European application No. 15307103.0 filed Dec. 22, 2015, the entirety of which are incorporated herein by reference for all purposes.

The present invention concerns compositions comprising cellulose acetate and plasticizers, a process for their production and their uses.

Cellulose acetate itself has no thermoplasticity. The use of an appropriate plasticizer in the thermal molding softens the polymer, decreases the glass transition temperature and gives rise to a temperature suitable for processing. Further, the addition of a plasticizer can improve the flexibility of a molded article. A list of typical plasticizers compatible with cellulose acetate is as follows: phthalates derivatives such as dibutylphthalate (DBP), diethylphthalate (DEP), dimethyl phthalate (DMP), di-2-methoxyethyl phthalate, ethyl phthalyl ethyl glycolate (EPEG) and methyl phthalyl glycolate (MPEG); citrate derivatives such as triethyl citrate and acetyl triethylcitrate; polyols, polyesters or oligoesters such as dibutyl tartrate, ethyl O-benzoylbenzoate, triacetin, triproprionin; phosphate derivatives such as triethyl phosphate (TEP) and triphenyl phosphate (TPP) and other derivatives such as o-cresyl p-toluensulfonate and N-ethyltoluenesulfonamide.

However, in making cellulose acetate plastics, constant trouble has been experienced owing to the tendency of plasticizers to separate or exude on the surface, out from the polymer matrix. For example, DEP tends to migrate from the cellulose acetate to some other plastic materials placed in close contact, including in particular polycarbonate, which is a material used in several components of eyewear, typically for manufacturing unbreakable spectacle lenses. This phenomenon is commonly known as plasticizer migration, also named plasticizer exudation or plasticizer demixing.

Some solutions have already been proposed.

By way of example, U.S. Pat. No. 1,930,069 describes that the tendency of exudation of the plasticizers from plastic materials containing organic derivatives of cellulose and plasticizers can be diminished by incorporating therein a relatively small proportion of a suitable resin, such as synthetic resin.

Further, U.S. Pat. No. 2,109,593 discloses that the addition of camphor to cellulose acetate and plasticizers can suppress the plasticizer exudation.

US2013/0169921 suggests to use two kinds of plasticizers in specific amounts, one of which being a citric acid ester in a plastic material based on cellulose acetate in the fields of eyewear and of jewelry.

However there is a constant need to propose new solutions to avoid plasticizer migration from plastic materials based on cellulose acetate whatever the application field.

There is also a constant need to propose new solutions to increase the maximal use temperature in application for a material comprising cellulose acetate.

Naturally, there is also a constant need that the above-mentioned improvements can be achieved while allowing the implementation of cellulose acetate in manufacturing processes without altering the rheological and mechanical properties of these materials, in particular with respect to the elastic Young modulus.

Thus, there is a need to provide compositions comprising cellulose acetate and plasticizers presenting an interesting compromise to avoid the phenomenon of exudation of the plasticizer(s) while facilitating its implementation in manufacturing processes (processability such as appropriate viscosity ranges), while increasing the maximal use temperature (also named operating temperature) in application for a material and while holding mechanical properties approaching those of plasticized cellulose acetate, in particular with respect to its elastic Young modulus.

The present invention has for purpose to meet these needs.

Therefore, the present invention concerns a composition comprising:
cellulose acetate (CA),
starch acetate (SA), and
at least one plasticizer,

wherein cellulose acetate is present in an amount of at least 50% by weight with respect to the total weight of cellulose acetate, starch acetate and plasticizer(s), and

wherein said at least one plasticizer is present in an amount of at most 18% by weight with respect to the total weight of cellulose acetate, starch acetate and plasticizer(s).

Some documents such as US2015/0090156, WO9616116 and US2006/0148943 describe blends of cellulose acetate, starch acetate and a plasticizer but none of these documents discloses the specific bounds of amounts of cellulose acetate and plasticizer(s) and deals with the exudation phenomenon technical problem.

Other documents such as U.S. Pat. No. 5,288,318 and Xia et al. publication (J. Polym. Environ., 2012, 20: 1103-1111, “A Biobased Blend of Cellulose Diacetate with Starch”) are also known but the blends which are described therein do not comprise starch acetate.

According to another subject-matter, the present invention concerns a process for the manufacture of a plasticized article comprising the steps of:

(a) providing a composition according to the present invention, and

(b) shaping the composition to produce the article, for example by means of extrusion and injection molding.

In a further aspect, the present invention relates to the use of a composition according to the present invention for producing a plasticized article, for example a plasticized article selected from a cosmetic packaging, food packaging, hair accessories, wiring devices, electronic devices, toys, consumer goods, engineering plastics, home appliances, eye glass frame and tool handle.

According to another subject-matter, the present invention relates to the use of starch acetate to prevent or diminish the exudation of one or more plasticizers from plastic materials containing cellulose acetate and such plasticizers, and/or to increase the maximal use temperature in application for a material comprising cellulose acetate while allowing the implementation of cellulose acetate in manufacturing processes without altering the rheological and mechanical properties of these materials,

wherein cellulose acetate is present in an amount of at least 50% by weight with respect to the total weight of cellulose acetate, starch acetate and plasticizer(s),

wherein said at least one plasticizer is present in an amount of at most 18% by weight with respect to the total weight of cellulose acetate, starch acetate and plasticizer(s).

Advantageously, in making cellulose acetate plastics, the use of starch acetate allows to decrease the amount of plasticizer(s) needed in the composition and thus the exudation phenomenon while increasing the maximal use temperature in application and while reaching the desired mechanical properties, in particular with respect to the elastic Young modulus.

The examples illustrate these various properties and corresponding compromise.

In the context of the present invention, the expression:
“exudation” (also named “migration to the air”) means that a product is released from a matrix of origin. More particularly in the framework of the present invention, exudation may be stated when the plasticizer releases from the cellulose acetate matrix over a period of time over 20 hours. The measure of the amount of plasticizer that can exudate from the cellulose acetate matrix may be performed by Isothermal ThermoGravimetric Analysis (I-TGA) at 60° C. during 20 hours, as it will be more particularly illustrated in the examples.

A composition according to the present invention is particularly advantageous in terms of plasticization that is to say glass transition temperature (Tg) and demixing limit of the plasticizer(s), processability (rheological behavior), value of the maximal use temperature in application for a material comprising plasticized cellulose acetate, thermo-mechanical properties, in particular with respect to the elastic Young modulus, and plasticizer migration.

More particularly, as shown in the examples, compared to cellulose acetate/triacetin blends, CA/SA/triacetin blends can lead to similar elastic Young modulus, higher maximal use temperature, nearly same processability in extrusion process and lower plasticizer migration.

Starch Acetate (Sa)

Starch is a biopolymer that is abundant in nature and inexpensive. It consists in linear a-D-glucan amylose and highly branched amylopectin.

Starch acetate is the acetate ester of starch.

In the present invention, the expression “starch acetate” refers to any conventional corn, potato, barley, wheat, oat, pea, maize, tapioca, sago, rye, sorghum, arrowroot, rice or a similar tuber-baring or grain plant material being acetylated by organic acids to a degree of substitution (DS) ranging between 0.5 and 3.0, advantageously between 1.5 and 3, more preferably between 2 and 3, and still more preferably between 2.4 and 2.7.

The molecular weight of starch acetate may range between 20000 g/mol and 200000 g/mol, more preferably between 40000 g/mol and 120000 g/mol, and still more preferably between 60000 g/mol and 110000 g/mol.

In a particular preferred embodiment, the amylose content present in starch acetate is in an amount from 0% to 100% by weight, more preferably from 20% to 90% and more preferably from 35% to 80% by weight, and still more preferably from 40% to 60% by weight with respect to the total weight of starch acetate.

In a preferred embodiment, the amylose is present in starch acetate in an amount equal to or greater than 20% by weight with respect to the total weight of SA.

Processes for the preparation of starch acetate are well known for the skilled person. For example, starch acetate can be prepared by allowing the starch to react with acetic acid anhydride in the presence of a catalyst such as 50% sodium hydroxide. By varying the amount of acetic acid anhydride, the amount and the reaction time of the base used as catalyst, starch acetate having different DS can be prepared.

In a composition according to the present invention, starch acetate is present in an amount from 5% to 45% by weight, preferably in an amount from 10%) to 40%) by weight, more preferably from 11> to 35% by weight, and still more preferably from 15% to 35% by weight with respect to the total weight of cellulose acetate, starch acetate and plasticizer(s).

Cellulose Acetate (Ca)

Cellulose acetate is an acetate ester of cellulose.

In the present invention, the expression “cellulose acetate” refers to any conventional wood pulp, cotton or any other cellulose material being acetylated by organic acids to a degree of substitution (DS) ranging between 1.0 to 3.0.

The relationship of cellulose acetate's DS to acetyl content and combined acetic acid is for example, as shown in the following Table.

| Compound | DS | Acetyl content | Acetic acid content |
|---|---|---|---|
| Cellulose monoacetate | 1 | 21.1% | 29.4% |
| Cellulose diacetate (CDA) | 2 | 34.9% | 48.8% |
| Cellulose triacetate (CTA) | 3 | 44.8% | 62.5% |

According to a particular embodiment of the invention, the cellulose acetate is obtained from cellulose from wood pulp, or from cellulose from cotton linters, that means containing at least 95% by weight of alpha cellulose. The amount of alpha cellulose is determined according to ISO standard 692.

Advantageously, the DS of the cellulose, which is also expressed as acetyl value (combined acetic acid (%)), is between 2 and 3, preferably between 2.0 and 2.6, and most preferably between 2.3 and 2.6. The degree of substitution of the cellulose is determined in accordance with ASTM D871-72.

The molecular weight of cellulose acetate may range between 30000 g/mol to 200000 g/mol, in particular between 50000 g/mol and 150000 g/mol and more particularly between 60000 g/mol and 120000 g/mol.

Among CA can be particularly cited those commercialized under the name of Rhodia Acetol® by Solvay, and Eastman™ Cellulose Acetate CA-398-3, Eastman™ Cellulose Acetate CA-398-6, Eastman™ Cellulose Acetate CA-398-10 and Eastman™ Cellulose Acetate CA-398-30 by Eastman Chemical Company.

Processes for the preparation of cellulose acetate are well known for the skilled person.

In a composition according to the present invention, cellulose acetate is present in an amount of at least 50% by weight, preferably in an amount from 50%) to 92% o by weight, more preferably from 55% to 90%> by weight, still more preferably from 60% to 80% by weight and most preferably from 60% to 70% by weight with respect to the total weight of cellulose acetate, starch acetate and plasticizer(s).

More precisely, CA may be present in an amount of 50%>, 51%, 52%, 53%, 54%, 55%, 56%, 57%, 58%, 59%, 60%, 61%, 62%, 63% 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, or 92% by weight with respect to the total weight of cellulose acetate, starch acetate and plasticizer(s).

Plasticizers

The composition according to the present invention comprises at least one plasticizer.

Among said plasticizers the following may be cited: triacetin (also known as glyceryl triacetate), triproprionin (also called glyceryl tripropionate), dibutylphthalate, diethyl phthalate, dimethyl phthalate, butyl phthalyl butyl glycolate, diethyl citrate, di-2-methoxy ethyl phthalate, ethyl phthalyl ethyl glycolate, methyl phthalyl ethyl glycolate, sulfonamides n-ethyl-o, p-toluene, triphenyl phosphate, tricresyl phosphate, dibutoxy ethyl phthalate, diamyl phthalate, triethyl citrate, ethyl O-benzoylbenzoate, tributyl citrate, acetyl triethyl citrate, acetyl tributyl citrate, acetyl tripropyl citrate, tripropionin, tributyrin, o,p-toluene sulfonamide, pentaerythritol tetraacetate, dibutyl tartrate, diethylene glycol diacetate, diethylene glycol dipropionate, dibutyl adipate, dioctyl adipate, dibutyl azelate, trichloroethyl phosphate, tributyl phosphate, di-n-butyl sebacate, dimethyl sebacate, dioctyl sebacate, dibutyl phthalate, dioctyl phthalate, butylbenzyl phthalate, 2-ethylhexyl adipate, di-2-ethylhexyl phthalate, tri-(2-ethylhexyl) phosphate, triphenyl phosphate, triethyl phosphate, polyalkylene glycol such as polyethylene glycol and polypropylene glycol, sulfolane (also known as dioxothiolane or 2,3,4,5-tetrahydrothiophene-1,1-dioxane) and mixtures thereof.

Preferably the plasticizer is chosen among triacetin (TA), diethyl phthalate (DEP) and mixtures thereof, and more preferably the plasticizer is triacetin.

Among plasticizers can be particularly cited those commercialized under the name of Eastman™ Triacetin by Eastman Chemical Company, GTA by Polynt, Lanxess™ Triacetin by Lanxess, Provichem® 1622 by Proviron, and DEP by Polynt.

According to a particular embodiment, the plasticizer(s) is(are) different from an alkenyl succinic anhydride.

In a composition according to the present invention, the plasticizer(s) is(are) is present in an amount of at most 18% by weight with respect to the total weight of cellulose acetate, starch acetate and plasticizer(s), preferably from 5 to 18% by weight, more preferably from 6 to 18% by weight, more preferably from 7 to 18%) by weight, still more preferably from 8 to 17% by weight and most preferably from 10 to 15% by weight in particular with respect to the total weight of cellulose acetate, starch acetate and plasticizer(s).

More precisely, the plasticizer(s) may be present in an amount of 5%, 6%, 7%, 8%, 9%, 10%, 11%, 12%, 13%, 14%, 15%, 16%, 17% or 18% by weight with respect to the total weight of cellulose acetate, starch acetate and plasticizer(s).

Advantageously, the amount of at most 18% by weight of plasticizer(s) with respect to the total weight of cellulose acetate, starch acetate and plasticizer(s) allows to avoid the plasticizer exudation phenomenon in the cellulose acetate plastics then obtained.

Another advantage provided by the amount of plasticizer(s) is that its increase, although being at most 18% by weight, allows to decrease the glass transition temperature of both CA and SA phases and the viscosity.

Composition

As mentioned above, the present invention relates to a composition comprising:
cellulose acetate,
starch acetate, and
at least one plasticizer,

wherein cellulose acetate is present in an amount of at least 50% by weight with respect to the total weight of cellulose acetate, starch acetate and plasticizer(s),

wherein said at least one plasticizer is present in an amount of at most 18% by weight with respect to the total weight of cellulose acetate, starch acetate and plasticizer(s).

In a preferred embodiment, a composition according to the invention comprises the following CA/SA/plasticizer(s) weight ratios: 90/5/5, 85/5/10, 85/10/5, 80/5/15, 80/10/10, 80/15/5, 75/10/15, 75/15/10, 75/20/5, 70/15/15, 70/20/10, 70/25/5, 65/20/15, 65/25/10, 65/30/5, 60/25/15, 60/30/10, 60/35/5, 50/45/5, 50/40/10, 50/35/15.

In a most preferred embodiment, a composition according to the invention comprises a CA/SA/plasticizer(s) weight ratio which ranges from 75/10/15 to 65/20/15, and which is for example 75/10/15, 70/15/15, or 65/20/15.

In a still most preferred embodiment, a composition according to the invention comprises the following CA/SA/plasticizer(s) weight ratio: 70/15/15.

As shown in the experimental part, the weight ratio 70/15/15 provides an additional benefit to the compositions according to the invention which consists in a similar impact resistance compared to CA/TA binary blends with the same amount of plasticizer(s).

For example, a weight ratio of 50/35/15 means that the composition comprises 50%> by weight of CA, 35% by weight of SA and 15% by weight of plasticizer(s) with respect to the total weight of cellulose acetate, starch acetate and plasticizer(s).

As mentioned above, preferably the plasticizer is chosen among triacetin (TA), diethyl phthalate (DEP) and mixtures thereof, and more preferably the plasticizer is triacetin.

Thus, according to a particular embodiment, a composition according to the invention comprises the following CA/SA/TA weight ratio: 90/5/5, 85/5/10, 85/10/5, 80/5/15, 80/10/10, 80/15/5, 75/10/15, 75/15/10, 75/20/5, 70/15/15, 70/20/10, 70/25/5, 65/20/15, 65/25/10, 65/30/5, 60/25/15, 60/30/10, 60/35/5, 50/45/5, 50/40/10, 50/35/15.

In a more preferred embodiment, a composition according to the invention comprises a CA/SA/TA weight ratio which ranges from 75/10/15 to 65/20/15, and which is for example 75/10/15, 70/15/15, or 65/20/15.

In a still most preferred embodiment, a composition according to the invention comprises the following CA/SA/TA weight ratio: 70/15/15.

In a most preferred embodiment, the composition comprises the following CA/SA/plasticizer(s) weight ratio: 70/15/15 the percentage by weight of amylose contained in starch acetate being at least 20%, preferably 35%, most preferably 60%, with respect to the total weight of starch acetate.

According to a particular embodiment, a composition according to the invention comprises a CA/SA/TA weight ratio of 70/15/15, the percentage by weight of amylose contained in starch acetate being at least 20%, preferably 35%), most preferably 60%>, with respect to the total weight of starch acetate.

It has to be noted that even if according to a preferred embodiment, the percentage by weight of amylose contained in starch acetate is at least 20%, with respect to the total weight of starch acetate, as mentioned above the composition according to the invention can comprise starch acetate with a percentage by weight of amylose which ranges from 0% to any percentage until 100%, with respect to the total weight of starch acetate.

This is clearly shown in the experimental part.

The composition according to the invention may further encompass at least one additional compound.

Among said additional compounds, anti-UV compounds or UV absorbers, thermal stabilizers (including antioxidants, phenolic and phosphite), light stabilizers (including Hindered Amine Light Stabilizers—HALS), acid scavengers, lubricants, pigments, dyes, odor maskers, brighteners and mixtures thereof may be cited, as any other optional additives usually used to prepare cellulose acetate and/or starch acetate, for example depending on the application.

When present, the additional compounds may be present in the composition in a content ranging from 0.05 to 15% by weight and preferably ranging from 0.1 to 10% by weight relative to the total weight of the composition.

It is a matter of routine operations for a person skilled in the art to adjust the nature and amount of the additional compounds present in the compositions in accordance with the invention such that the desired properties thereof are not thereby affected.

More precisely, the presence of an additional compound should not alter the desired properties, in particular with respect to the plasticizing power and the absence or decreasing of exudation.

Properties

As explained above, the compositions according to the invention present an interesting compromise which consists in at least:
to avoid the phenomenon of exudation of the plasticizer(s);
to increase the maximal use temperature in application for a material comprising CA; and
while allowing the implementation of cellulose acetate in manufacturing processes (processability such as appropriate viscosity ranges) without altering the rheological and mechanical properties of these materials, in particular with respect to the elastic Young modulus.

Moreover, as additional property, some particular ternary blends and in particular the ternary blend with a weight ratio which ranges from 75/10/15 to 65/20/15, and which is for example 75/10/15, 70/15/15, or 65/20/15 and most preferably 70/15/15 allow to provide to the compositions according to the invention a similar impact resistance compared to CA/TA binary blends, with the same amount of plasticizer(s).

All these properties are demonstrated in the experimental part as detailed below.

1. Exudation of the Plasticizer(s)

This property can be demonstrated by performing a method which consists in Isothermal ThermoGravimetric Analysis (I-TGA) at a given temperature (generally higher than ambient temperature, more particularly from 30° C. to 180° C., more preferably from 40° C. to 120° C., still more preferably from 50° C. to 80° C., most preferably from 55° C. to 65° C., and for example 60° C.) during a given time (generally several hours, more particularly from 1 hour to 170 hours, more preferably from 5 hours to 48 hours).

I-TGA permits to measure the amount of plasticizer that can migrate outside the polymer matrix over time. This is a common way for observing the accelerated exudation of the plasticizer from the polymer matrix and identify the difference between the behavior a different typologies of plasticizers.

Isothermal ThermoGravimetric Analysis can be carried out with an appropriate apparatus, for example TG209 Fl Thermogravimetric Analyser® commercialized by the NETZSCH Company, and can be performed for each ternary blend according to the invention on plates obtained from injection molding techniques at a temperature of 60° C. during 20 hours.

These measurements can be compared to results obtained with comparative CA/TA binary blends following obviously the same time-temperature conditions.

Typically, a composition according to the invention has an exudation amount which ranges from 0.1 to 1% by weight, preferably from 0.2 to 0.8% by weight, more preferably from 0.3 to 0.7% by weight, still more preferably from 0.3 to 0.6%) by weight and typically the exudation amount can be 0.1%, 0.2%>, 0.3%, 0.4%, 0.5%, 0.6%, 0.7%, 0.8%, 0.9% or 1% by weight.

In other words, a composition according to the invention provides from 10 to 2 times less exudation, preferably from 7 to 3, compared to CA/TA binary blends, with the same amount of plasticizer(s).

The example 4 as shown below illustrates the quantitative evaluation of resistance to exudation of the ternary blend compositions according to the invention compared to comparative CA/TA binary blends.

2. Implementation of Cellulose Acetate in Manufacturing Processes

This property can be demonstrated by performing a method as explained below.

A composition according to the invention comprising CA/SA/TA ternary blends can be prepared through melt extrusion by using a microcompounder.

During the processing, the axial force (also named force at the plateau) applied can be recorded by a force sensing cell. This force is an indication of the material viscosity, and of the processability of the given composition.

Typically, the force at the plateau of a composition according to the invention can range from 1000 N to 6000 N, preferably from 2000 N to 5000 N, and still preferably is 4800 N.

The example 1, as shown below illustrates that the implementation of CA in manufacturing processes is facilitated for ternary blends according to the invention compared to CA/TA comparative binary blends.

3. Maximal Use Temperature in Application for a Material Comprising CA

This property can be demonstrated by performing a DMTA (Dynamic Mechanical Thermal Analysis) thermogram of ternary blend compositions CA/SA/TA according to the invention and of binary blend CA/TA comparative compositions.

A DMTA RSA II Rheometrics Scientific can be used in the linear response domain.

The temperature until which the elastic modulus E (Young modulus) is kept larger than 1 GPa is determined to evaluate the maximal use temperature in applications.

Typically, the maximal use temperature in application for a material comprising CA when using a composition according to the invention is at least 50° C., preferably ranges between 50° C. and 140° C., and still preferably is greater than 100° C.

In other words, a composition according to the invention provides a maximal use temperature in application from 10% to 100% higher than the one for CA/TA binary blends, with the same amount of plasticizer(s), preferably from 30% to 90% higher than the one for CA/TA binary blends, with the same amount of plasticizer(s).

The example 3, as shown below, illustrates the ability to improve the operating temperature range of a material made of compositions according to the invention compared to CA/TA binary blends.

4. Elastic Young Modulus

Different mechanical properties can be measured on plates of ternary blends according to the invention obtained from injection molding techniques. These properties can concern the following specific measurement:
Tensile Testing at room temperature according to ISO standard 527-1 and 527-2. Tensile testing permits to reach mechanical parameters such as Young Modulus.

These measurements can also be compared to results obtained with comparative blends such as comparative CA/TA binary blends, for example 70/30 or 85/15, obviously realized under the same experimental conditions.

Typically, a composition according to the invention comprises the following CA/SA/plasticizer(s) weight ratios: 90/5/5, 85/5/10, 85/10/5, 80/5/15, 80/10/10, 80/15/5, 75/10/15, 75/15/10, 75/20/5, 70/15/15, 70/20/10, 70/25/5, 65/20/15, 65/25/10, 65/30/5, 60/25/15, 60/30/10, 60/35/5, 50/45/5, 50/40/10, 50/35/15.

The example 4, as shown below, illustrates the measurement of the mechanical properties of the ternary blends according to the invention such as the elastic Young modulus compared to comparative CA/TA binary blends.

5. Impact Resistance

The mechanical properties can also concern the following specific measurement:
Notched Charpy Impact Testing at room temperature according to ISO standard 179/leA. Charpy impact test permit to access to parameters such as Impact Resistance.

These measurements can also be compared to results obtained with comparative blends such as comparative CA/TA binary blends, for example 70/30 or 85/15, obviously realized under the same experimental conditions.

Thus, some particular ternary blends and in particular the ternary blend with a weight ratio which ranges from 75/10/15 to 65/20/15, and which is for example 75/10/15, 70/15/15, or 65/20/15 and most preferably 70/15/15 allow to provide to the compositions according to the invention a similar impact resistance compared to CA/TA binary blends, with the same amount of plasticizer(s).

Typically, the impact resistance for a ternary blend according to the invention with a weight ratio ranging from 75/10/15 to 65/20/15, ranges from 1 to 5 kJ/m².

More particularly, the impact resistance for a 70/15/15 ternary blend according to the invention ranges from 3.0 to 4.0 kJ/m², more preferably from 3.1 to 3.9 kJ/m², still more preferably from 3.2 to 3.8 kJ/m², even more preferably from 3.3 to 3.8 kJ/m², and typically is 3.5 kJ/m².

The example 4, as shown below, illustrates the measurement of the mechanical properties of the ternary blends according to the invention such as the impact resistance compared to comparative CA/TA binary blends.

Process According to the Invention

A composition according to the present invention may be prepared according to the general knowledge of a person skilled in the art.

The plasticizer may be liquid or solid.

The preparation of the composition according to the present invention may merely consist in a direct implementation by a melt way of a mixture of the cellulose acetate, the starch acetate with the plasticizer and optionally with at least one additional compound as defined above. It may more precisely consist in blending the melted cellulose acetate, the starch acetate, the plasticizer and the at least one additional compound. The processing temperature may be preferably set between 140 and 240° C.

The process for the manufacture of a plasticized article also forms part of the invention. Therefore the present invention also concerns a process for the manufacture of a plasticized article comprising the steps of:

(a) providing a composition according to the present invention, and

(b) shaping the composition to produce the article.

Step (b) may be performed according to usual means known from the man skilled in the art, i.e. extrusion and injection molding.

Applications Depending on the way it has been processed the composition according to the present invention comprising cellulose acetate, starch acetate and at least one plasticizer, can be used for great varieties of applications (e.g. for films, membranes or fibers and also for 3D objects).

A plasticized article as a 3D object may be for example a cosmetic packaging, food packaging, hair accessories, wiring devices, electronic devices, toys, consumer goods, engineering plastics, home appliances, eye glass frames and tool handles.

Throughout the description, including the claims, the term “comprising a” should be understood as being synonymous with “comprising at least one”, unless otherwise mentioned.

The terms “between . . . and . . . ” and “ranging from . . . to . . . ” should be understood as being inclusive of the limits, unless otherwise specified.

The terms “at most . . . ” and “at least . . . ” should be understood as being inclusive of the limits, unless otherwise specified.

The examples below of compositions according to the invention are given as illustrations with no limiting nature.

Should the disclosure of any patents, patent applications, and publications which are incorporated herein by reference conflict with the description of the present application to the extent that it may render a term unclear, the present description shall take precedence.

### EXAMPLES

### Example 1: Preparation, Through Melt Extrusion of Ternary Blends According to the Invention and of Comparative Binary Blends, at Screening Scale (˜10 Grams of Material)

Three compositions according to the invention comprising CA/SA/TA ternary blends (CI, C2 and C3) and two comparative binary blends CA/TA (C4 and C5) are prepared through melt extrusion by using a microcompounder.

As shown in Table 1 below, concerning the compositions according to the invention, three kinds of SA (SA 1, SA 2 and SA 3) comprising a specific amylose content, a specific DS and a specific viscosity in solution and one kind of CA (CA 1) comprising a specific DS are used. More particularly, CA 1 is a cellulose acetate sold under the name Rhodia Acetol® by Solvay Company and TA is a triacetin sold under the name Eastman™ Triacetin by Eastman Chemical Company.

Concerning the comparative binary blends CA/TA, the same CA (that is to say CA 1) and the same TA as the ones used for ternary blends according to the invention are used.

All the components: powder of CA and optionally SA, triacetin liquid plasticizer are first dry blended in the correct ratio; and then introduced in the microcompounder for the melt blending to obtain the ternary compound.

The respective weight ratios of the ternary blends according to the invention and of the comparative binary blends are indicated in Table 1.

For example, when 10 grams of material are prepared, 5 g of CA, 3.5 g of SA and 1.5 g of TA are used in order to obtain a ternary blend according to the invention with a weight ratio 50/35/15.

By analogy, when 10 grams of material are prepared, 7 g of CA, and 3 g of TA are used in order to obtain a comparative binary blend with a weight ratio 70/30.

The microcompounder used (DSM Midi® 2000 commercialized by DSM) is a batch mini-extruder (15 mL leading to ˜10 grams of product per run) with 2 co-rotating conic screws. It operates under inert atmosphere (N2) but it is not completely tight. This tool allows controlling the residence time, independently of screw speed, using a recirculating system. The following process conditions are used:

Barrel temperature: 180° C.

Screw speed: 100 rpm

Residence time: 5 min

During the processing, the axial force (that is to say “force at the plateau”) applied is recorded by a force sensing cell. This force is an indication of the material viscosity, and of the processability of the given composition. The corresponding values of the force at the plateau are summarized in Table 1.

TABLE 1

| | Starch acetate | | | | | | Composition | |
|---|---|---|---|---|---|---|---|---|
| | | | | Viscosity in | Cellulose acetate | | CA/(SA)/ | Force at |
| | Starch | Amylose | | solution | Cellulose | | triacetin | the plateau |
| Composition | acetate | content | DS | (cP) | acetate | DS | (% wt/wt/wt) | (N) |
| C1 according to | SA 1 | 20% | 2.62 | 60 | CA 1 | 2.45 | 50/35/15 | 4800 |
| the invention | | | | | | | | |
| C2 according to | SA2 | 35% | 2.57 | 75 | CA 1 | 2.45 | 50/35/15 | 4800 |
| the invention | | | | | | | | |
| C3 according to | SA3 | 60% | 2.58 | 63 | CA 1 | 2.45 | 50/35/15 | 4800 |
| the invention | | | | | | | | |
| Comparative C4 | — | — | — | — | CA 1 | 2.45 | 70/30 | 3000 |
| | | | | | | | | (50 rpm for |
| | | | | | | | | screw speed) |
| Comparative C5 | — | — | — | — | CA 1 | 2.45 | 80/20 | 6400 |
| | | | | | | | | (50 rpm for |
| | | | | | | | | screw speed) |

Conclusion

At 180° C., according to axial force measured, whatever the amylose content in the SA, the ternary blend (50/35/15) exhibits typically a viscosity between the binary 80/20 and the binary 70/30.

Thus, the processability in melt processes of this ternary blend composition is expected to stand between CA/TA blends 80/20 and 70/30 ones.

### Example 2: Preparation, Through Melt Extrusion of Ternary Blends According to the Invention and of Comparative Binary Blends, at Lab Scale (Few Tens of Kg of Material)

Three compositions according to the invention comprising CA/SA/TA ternary blends (C6, C7 and C8) and two comparative binary blends CA/TA (C9 and CIO) are prepared in twin screw extrusion.

As shown in Table 2 below, concerning the compositions according to the invention, one kind of SA (SA 1) comprising a specific amylose content, a specific DS and a specific viscosity in solution and one kind of CA (CA 2) comprising a specific DS are used. More particularly, CA 2 is a cellulose acetate sold under the name Rhodia Acetol® by Solvay Company and TA is a triacetin sold under the name Eastman™ Triacetin by Eastman Chemical Company.

Concerning the comparative binary blends CA/TA, the same CA (that is to say CA 2) and the same TA as the ones used for ternary blends according to the invention are used.

The respective weight ratios of the ternary blends according to the invention and of the comparative binary blends are indicated in Table 2.

A twin screw extruder Clextral, with a diameter 32 mm and a length over diameter ratio L/D of 44 is used. All the components are introduced in the 2 first zones of the barrel. The following conditions are used:

Rate: 10 kg/h

Screw speed: 200 rpm

Temperatures profile from the feeding zone to the die: from 20° C. to 225° C.

At the exit of the die, the stand is granulated. 25 kg of each composition are prepared to be then molded in injection.

The pellets prepared are then molded through injection molding process to form disks of 3 mm thick, diameter 85 mm and tensile bars 1 A IS0527. An injection molding machine BILLION® H260/100 commercialized by BILLION is used, with the following conditions:

Barrel temperatures along the single screw from the feeding zone to the nozzle: from 210° C. to 240° C.

Mold temperature: 30° C.

Injection cycle time: from 48 to 57 s

The following table 2 summarizes the compositions realized.

TABLE 2

| | | | | | Cellulose acetate | | | |
|---|---|---|---|---|---|---|---|---|
| | Starch acetate | | | | | | Specific | Composition |
| | | | | Viscosity in | | | viscosity | CA/(SA)/ |
| | Starch | Amylose | | solution | Cellulose | Acetyl | (ASTM | triacetin |
| Composition | acetate | content | OS | (cP) | acetate | title | D871-72) | (% wt/wt/wt) |
| C6 according to | SA4 | 60% | 2.43 | 74 | CA2 | 55.2% | 0.332 | 50/35/15 |
| the invention | | | | | | | | |
| C7 according to | SA4 | 60% | 2.43 | 74 | CA2 | 55.2% | 0.332 | 60/25/15 |
| the invention | | | | | | | | |
| C8 according to | SA4 | 60% | 2.43 | 74 | CA2 | 55.2% | 0.332 | 70/15/15 |
| the invention | | | | | | | | |
| Comparative C9 | — | — | — | — | CA2 | 55.2% | 0.332 | 70/30 |
| Comparative C1O | — | — | — | — | CA2 | 55.2% | 0.332 | 85/15 |

### Example 3: Properties of Ternary Blends According to the Invention (CI) Versus Comparative Binary Blends (C4 and C5) at Screening Scale—Maximum Use Temperature in Application

DMTA thermograms of the ternary blend composition according to the invention named CI and of two comparative binary blends named C4 and C5 which are prepared at screening scale in example 1 are performed. A DMTA RSA II Rheometrics Scientific is used, in the linear response domain. The temperature until which the elastic modulus E is kept larger than 1 GPa is determined to evaluate the maximal use temperature in applications.

The results are summarized in Table 3 below.

TABLE 3

| | Starch acetate | | | | Cellulose | | Composition | |
|---|---|---|---|---|---|---|---|---|
| | | | | Viscosity in | acetate | | CA/(SA)/ | Temperature |
| | Starch | Amylose | | solution | Cellulose | | triacetin | until which |
| Composition | acetate | content | DS | (cP) | acetate | DS | (% wt/wt/wt) | E′ > lGPa |
| C1 according to | SA 1 | 20% | 2.62 | 60 | CA 1 | 2.45 | 50/35/15 | 110° C. |
| the invention | | | | | | | | |
| Comparative C4 | — | — | — | — | CA 1 | 2.45 | 70/30 | 60° C. |
| Comparative C5 | — | — | — | — | CA 1 | 2.45 | 80/20 | 80° C. |

Conclusion

So, ternary blends according to the invention can be used at larger temperatures, keeping a good level of mechanical properties, than comparative binary CA/TA blends.

### Example 4: Properties of Ternary Blends According to the Invention (C6, C7 and C8) Versus Comparative Binary Blends (C9 and CIO) at Lab Scale—Resistance to Exudation—Mechanical Properties

Quantitative Evaluation of Resistance to Exudation of the Different Ternary Blend Compositions According to the Invention (C6, C7 and C8)

Isothermal ThermoGravimetric Analysis (I-TGA) performed at a given temperature (generally higher than ambient temperature) during a given time (generally several hours) permits to measure the amount of plasticizer that can migrate outside the polymer matrix over time. This is a common way for observing the accelerated exudation of the plasticizer from the polymer matrix and identify the difference between the behavior a different typologies of plasticizers.

Isothermal ThermoGravimetric Analysis (I-TGA) is carried out with TG209 Fl Thermogravimetric Analyser® commercialized by the NETZSCH Company and is performed at 60° C. during 20 hours for each ternary blend according to the invention on plates obtained from injection molding techniques in example 2, that is to say for C6, C7 and C8 according to the invention. These measurements are compared to results obtained with two comparative CA/TA binary blends (70/30 and 85/15, that is to say respectively comparative C9 and CIO) following obviously the same time-temperature conditions.

Comparative 70/30 (comparative C9) binary blend corresponds to a ‘classical’ amount of plasticizer (30% by weight with respect to the total weight of CA and plasticizer(s)) permitting the melt processing of Cellulose. The minimum amount of plasticizer required for plasticizing Cellulose Acetate is around 5% by weight. However, even if it is associated to a higher amount of plasticizer, the comparative 85/15 (comparative CIO) binary blend corresponds to a situation much more critical than the classical 70/30 composition in terms of Cellulose Acetate plasticization process.

Measurements of the Mechanical Properties of the Ternary Blends According to the Invention (C6, C7 and C8)

Different mechanical properties are measured on plates of ternary blends obtained from injection molding techniques, in example 2. These properties concern the following specific measurements:
Tensile Testing at room temperature according to ISO standard 527-1 and 527-2. Tensile testing permits to reach mechanical parameters such as Young Modulus, Yield Stress and deformation at Break;
Notched Charpy Impact Testing at room temperature according to ISO standard 179/leA. Charpy impact test permit to access to parameters such as Impact Resistance

These measurements are also compared to results obtained with two comparative CA/TA binary blends (70/30 and 85/15, that is to say respectively comparative C9 and CIO) obviously realized under the same experimental conditions in example 2.

The results of mechanical properties and of resistance to exudation are summarized in the following Tables 4 and 5:

TABLE 4

| | Composition | Exudation | |
|---|---|---|---|
| | CA/(SA)/triacetin | amount | Young Modulus |
| Composition | (% wt/wt/wt) | (% w) | (MPa) |
| C6 according to the | 50/35/15 | 0.3 (±0.1) | 2809 (±215) |
| invention | | | |
| C7 according to the | 60/25/15 | 0.6 (±0.1) | 2897 (±142) |
| invention | | | |
| C8 according to the | 70/15/15 | 0.6 (±0.1) | 2880 (±108) |
| invention | | | |
| Comparative C9 | 70/30 | 3.9 (±0.3) | 1663 (±102) |
| Comparative C10 | 85/15 | 1.6 (±0.3) | 3677 (±111) |

TABLE 5

| | Composition | Yield | Deformation | Impact |
|---|---|---|---|---|
| | CA/(SA)/triacetin | Stress | at break | resistance |
| Composition | (% wt/wt/wt) | (MPa) | (%) | (kJ/m2) |
| C8 according to the | 70/15/15 | 55.6 (±0.7) | 9.2 (±1.1) | 3.5 (±0.4) |
| invention | | | | |
| Comparative C9 | 70/30 | 25.4 (±1.4) | 14.6 (±2.1) | 15.4 (±2.6) |
| Comparative C10 | 85/15 | 71.6 (±0.9) | 7.0 (±0.6) | 3.7 (±0.7) |

Conclusion

It is deduced from these specific data that blends of CA/SA according to the invention retain much more the plasticizer(s) than CA itself (considered alone, comparative binary blends). These observations are particularly effective if the exudation of triacetin (TA) from the 70/15/15 ternary blend is compared with the exudation of the same plasticizer from the comparative binary blend containing the same amount (85/15) where a factor 2.7 in terms of decreasing of exudation is measured.

In terms of mechanical properties, the results obtained clearly show that: The mechanical properties of the 70/15/15 ternary blend according to the invention stand in the range of properties defined by the two comparative binary blends for both tensile testing and notched impact testing.

After a strict comparison between the results coming from the different examples (examples 3 and 4), it appears that the 70/15/15 ternary blend composition assumes the best compromise of properties, considering the resistance to exudation, the maximum use temperature in applications and the level of the mechanical performances of the corresponding material.

1. A composition comprising:
cellulose acetate,
starch acetate, and
at least one plasticizer,
wherein the cellulose acetate is present in an amount of at least 50% by weight with respect to the total weight of the cellulose acetate, the starch acetate and the at least one plasticizer, and
wherein the at least one plasticizer is present in an amount from 5 to 18% by weight with respect to the total weight of the cellulose acetate, the starch acetate and the at least one plasticizer.

2. The composition according to claim 1, wherein the at least one plasticizer is different from an alkenyl succinic anhydride.

3. The composition according to claim 1, wherein the cellulose acetate is present in an amount of 50% to 92% by weight with respect to the total weight of the cellulose acetate, the starch acetate and the at least one plasticizer.

4. The composition according to claim 1, wherein a DS of the cellulose is between 2 and 3.

5. The composition according to claim 1, wherein a molecular weight if of the cellulose acetate ranges between 30000 g/mol to 200000 g/mol.

6. The composition according to claim 1, wherein the starch acetate is present in an amount from 5% to 45% by weight with respect to the total weight of the cellulose acetate, the starch acetate and the at least one plasticizer.

7. The composition according to claim 1, wherein a degree of substitution of the starch acetate ranges between 0.5 and 3.0.

8. The composition according to claim 1, wherein a molecular weight of the starch acetate ranges between 20000 g/mol and 200000 g/mol.

9. The composition according to claim 1, wherein the amylose content present in the starch acetate is in an amount from 20% to 90% with respect to the total weight of the starch acetate.

10. The composition according to claim 1, wherein the cellulose acetate/starch acetate/plasticizer(s) weight ratio is at least one of 90/5/5, 85/5/10, 85/10/5, 80/5/15, 80/10/10, 80/15/5, 75/10/15, 75/15/10, 75/20/5, 70/15/15, 70/20/10, 70/25/5, 65/20/15, 65/25/10, 65/30/5, 60/25/15, 60/30/10, 60/35/5, 50/45/5, 50/40/10, or 50/35/15.

11. The composition according to claim 10, wherein the cellulose acetate/starch acetate/plasticizer(s) weight ratio is 70/15/15.

12. The composition according to claim 1, further comprising at least one of anti-UV compounds, UV absorbers, thermal stabilizers, light stabilizers, acid scavengers, lubricants, pigments, dyes, odor maskers, brighteners or mixtures thereof.

13. A process for the manufacture of a plasticized article comprising the steps of:
(a) providing the composition according to claim 1, and
(b) shaping by extruding or injection molding, the composition to produce the article.

14. (canceled)

15. (canceled)

16. The composition according to claim 3, wherein the cellulose acetate is present in an amount of 55% to 90% by weight with respect to the total weight of the cellulose acetate, the starch acetate and the at least one plasticizer.

17. The composition according to claim 4, wherein the DS of the cellulose is between 2.0 and 2.6.

18. The composition according to claim 5, wherein the molecular weight of the cellulose acetate ranges between 50000 g/mol and 150000 g/mol.

19. The composition according to claim 6, wherein the starch acetate is present in an amount from 10% to 40% by weight with respect to the total weight of the cellulose acetate, the starch acetate and the at least one plasticizer.

20. The composition according to claim 7, wherein the degree of substitution of the starch acetate ranges between 1.5 and 3.

21. The composition according to claim 8, wherein the molecular weight of the starch acetate ranges between 40000 g/mol and 120000 g/mol.

22. The composition according to claim 9, wherein the amylose content present in the starch acetate is in an amount from 35% to 80% by weight with respect to the total weight of the starch acetate.
